(19) United States
(12) Patent Application Publication
(10) Pub. No.: US 2004/0262436 A1
(43) Pub. Date: Dec. 30, 2004

(54) Paper shredder cutting tool having multiple cutting edges

(76) Inventor: Emily Lo, Taipei Shien (TW)

Correspondence Address: BACON & THOMAS, PLLC, 625 SLATERS LANE, FOURTH FLOOR, ALEXANDRIA, VA, 22314

(21) Appl. No.: 10/749,556

(22) Filed: Jan. 2, 2004

(30) Foreign Application Priority Data
Jun. 30, 2003 (CN) 03266225.4

(51) Int. Cl. B02C 18/16

(52) U.S. Cl. 241/236

(57) ABSTRACT

A paper shredder cutting tool having multiple cutting edges constructed from a pair of cylindrical rotary cutters, which are each separately mounted on a hexagonal shaft, and a plurality of cutting blades are securely mounted on the shafts. A spacer is configured between each pair of adjacent cutting blades, thus partitioning the cutting blades therebetween, and thereby allowing the cutting blades to be assembled and mounted in an interleaving fashion on the two cylindrical rotary cutters. Moreover, each of the cutting blades is further constructed from a pair of blades. The present invention is characterized in having a plurality of cutting edges circumferentially arranged and minimally separated on each of the pair of blades, thereby forming a compact assembly of blade edges. The paper shredder cutting tool provides capability to feed around twenty sheets of paper or cardboard at one time, thereupon being rapidly shredded into small bits.

### BACKGROUND OF THE INVENTION

(a) Field of the Invention

The present invention relates to paper shredders, and more particularly to a paper shredder cutting tool having multiple cutting edges, whereby the multiple cutting edges are defined on a pair of blades making up cutting blades, and so configured so as to form a compact assembly, thereby realizing minimum distance between mutually adjacent cutting edges, accordingly quickly and with greater effectiveness shredding a multitude of pieces of paper or cardboard at one time.

(b) Description of the Prior Art

Referring to FIG. 1, which shows a conventional paper shredder cutting tool constructed to include a pair of cylindrical rotary cutters 1 and 1′, which are configured to rotate in opposite directions to each other, and further includes an electric motor and an internal gear drive mechanism configured to drive the cutting tool thereof. Each cylindrical rotary cutter includes a polygonal shaft 2 (a hexagonal shaft is depicted in FIG. 1), and a plurality of cutting blades 4 are mounted on the shaft 4. A spacer 6 is configured between each pair of adjacent cutting blades 4, thus partitioning the cutting blades 4 therebetween, and thereby allowing the cutting blades 4 to be assembled and mounted in an interleaving fashion on the two cylindrical rotary cutters 1 and 1′. The traditional cutting blade 4 is provided with a central aperture shaped to correspond to the shaft 2, and 3 to 4 equiangular spaced cutting edges 8 are further defined on a circumferential periphery of the cutting blade 4 thereof

Although the aforementioned traditional paper shredder cutting tool can achieve a degree of effectiveness in shredding paper, however, the traditional paper shredder cutting tool still has serious shortcomings as described hereafter:

1. Spacing between two adjacent cutting edges is too great, and thereby restricts what paper can be shredded, and thus limits shredding to 1 to 2 sheets of paper at one time, and is unable to shred thicker sheets of paper (or cardboard).

2. The cutting tool shreds the paper into thin strips, and is unable to shred the paper into small bits, and thus comparatively quickly fills up a shredded paper can of the traditional paper shredder.

3. Speed of shredding the paper is comparatively slow, and remnants of shredded paper easily remain stuck in the cutting blades, and apt to cause malfunction of the traditional paper shredder.

### SUMMARY OF THE INVENTION

Therefore, a primary objective of the present invention is to provide a cutting blade configured from a pair of blades each defined with a plurality of cutting edges, thereby assembling a compact arrangement of cutting edges, and realizing a small spacing between adjacent cutting edges to be reduced to a minimum, and therefrom forming a fast and powerful cutting tool. The present invention actualizes practicability of allowing several tens of sheets of paper or cardboard to be simultaneously fed into the paper shredder and still be easily pulled and dragged into the rotary cutters and shredded into small bits thereof.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view of a conventional paper shredder cutting tool.

FIG. 2 shows a schematic view according to the present invention.

FIG. 3 shows a top view according to the present invention.

FIG. 4 shows a partial exploded elevational view according to the present invention.

FIG. 5 shows a side view of assembled cutting blades according to the present invention.

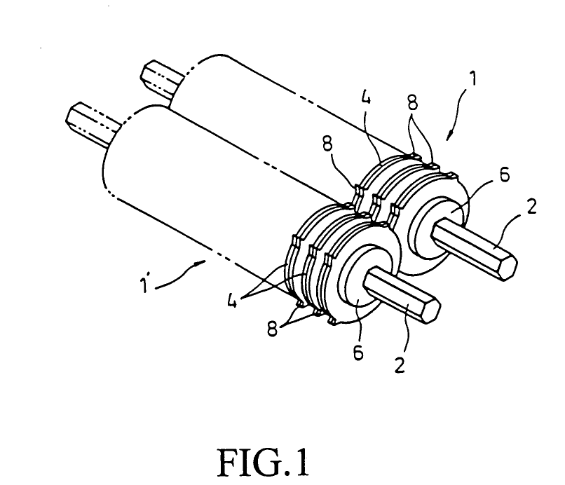

### DETAILED DESCRIPTION OF THE PREFERRED EMBODIMENTS

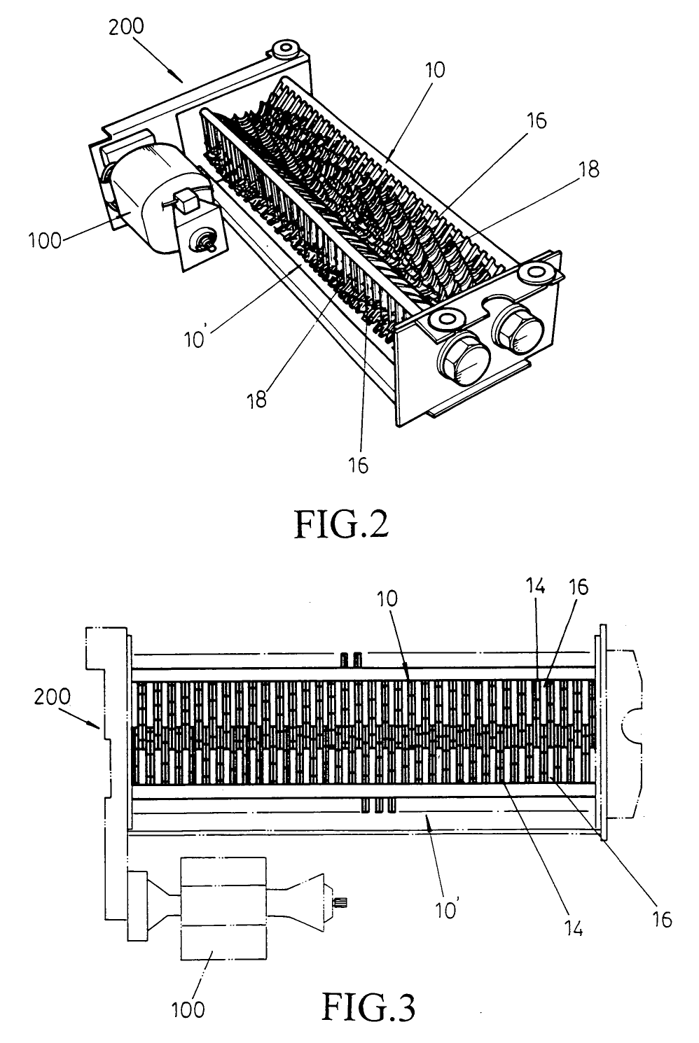

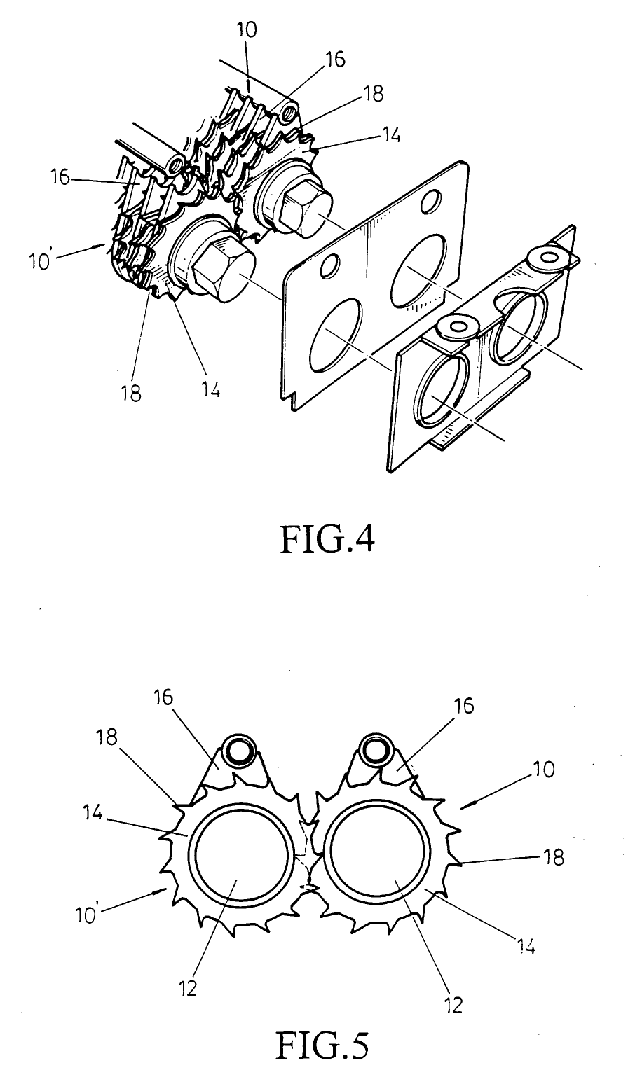

Referring to FIGS. 2 and 3, which show a paper shredder of the present invention comprising an electric motor 100, which drives and thereby rotates a decelerator 200 comprising a number of gears. The decelerator 200 axially connects to shafts of two cutting tools, the two cutting tools being constructed to include two cylindrical rotary cutters 10 and 10′. Each of the rotary cutter 10 and 10′ are mounted on a hexagonal shaft 12, and a plurality of cutting blades 14 are securely mounted on the shafts 12. A spacer 16 is configured between each pair of adjacent cutting blades 14, thus partitioning the cutting blades 14 therebetween, and thereby allowing the cutting blades 14 to be assembled and mounted in an interleaving fashion on the two cylindrical rotary cutters 10 and 10′. Moreover, each of the cutting blades 14 is further constructed from a pair of blades. The present invention is primarily characterized in that:

11 to 21 cutting edges 18 are respectively defined on the pair of blades of the cutting blades 14, thereby realizing minimum distance between mutually adjacent cutting edges 18 (as depicted in FIG. 5), and thus time paper comes into contact with the cutting edges 18 is very short, accordingly the cutting blades 14 slice the paper more quickly and with greater effectiveness. Furthermore, referring to FIG. 2, which shows the cutting blades 14 of the two cylindrical rotary cutters 10 and 10′ interleavingly mounted so as to form a compact assembly of blade edges, such that when a sheet of paper is fed between the two cutting blades 14, the sheet of paper is first pulled and dragged downwards and then shredded. Multiple sheets of paper or cardboard are also easily shredded into small pieces. The paper shredder cutting tool according to the present invention can simultaneously shred multiple sheets of paper when fed into the paper shredded at one time, thereby economizing on time required to shred the paper.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A paper shredder cutting tool having multiple cutting edges, comprising a pair of cylindrical rotary cutters, which are configured to rotate in opposite directions to each other, and each of the rotary cutters is mounted on a polygonal shaft, and a plurality of cutting blades are securely mounted on the shafts; a spacer is configured between each pair of adjacent cutting blades, thus partitioning the cutting blades therebetween, and thereby allowing the cutting blades to be assembled and mounted in an interleaving fashion on the two cylindrical rotary cutters, wherein each of the cutting blades is further constructed from a pair of blades; the paper shredder cutting tool is primarily characterized in that:
a plurality of cutting edges are circumferentially arranged and defined on a periphery of each of the pair of blades of the cutting blades, thereby forming a compact assembly of blade edges, and realizing minimum distance between mutually adjacent cutting edges; tens of sheets of paper or cardboard can be fed in between the cutting blades at one time, and thereupon pulled and dragged downwards and shredded into small bits thereat.

2. The paper shredder cutting tool having multiple cutting edges according to claim 1, wherein 11 to 21 cutting edges are preferably defined on the cutting blades.
